(19) United States
(12) Patent Application Publication
(10) Pub. No.: US 2022/0270592 A1
(43) Pub. Date: Aug. 25, 2022

(54) ALWAYS-ON WAKE ON MULTI-DIMENSIONAL PATTERN DETECTION (WOMPD) FROM A SENSOR FUSION CIRCUITRY

(71) Applicant: AONDEVICES, INC., Irvine, CA (US)

(72) Inventors: Mouna Elkhatib, Irvine, CA (US); Adil Benyassine, Irvine, CA (US); Aruna Vittal, Irvine, CA (US); Eli Uc, Irvine, CA (US); Daniel Schoch, Irvine, CA (US)

(21) Appl. No.: 17/675,947

(22) Filed: Feb. 18, 2022

Related U.S. Application Data
(60) Provisional application No. 63/151,250, filed on Feb. 19, 2021.

(51) Int. Cl. G10L 15/08; G10L 25/30

(52) U.S. Cl. CPC G10L 15/08; G10L 25/30; G10L 25/24

(57) ABSTRACT

A device wake-up system has one or more sensors each receptive to an external input. The respective external inputs are translatable to corresponding signals. One or more feature extractors connected to a respective one of the one or more sensors are receptive to the signals outputted from the sensors, and the feature data is associated with the signals being generated by the corresponding one of the one or more feature extractors. One or more inference circuits are connected to a respective one of the one or more feature extractors, and inference decisions are generated from patterns of the feature data generated by a corresponding one of the one or more feature extractors. A decision combiner is connected to each of the one or more inference circuits, and a wake signal is be generated based upon an aggregate of the inference decisions provided by the one or more inference circuits.

### CROSS-REFERENCE TO RELATED APPLICATIONS

This application relates to and claims the benefit of U.S. Provisional Application No. 63/151,250 filed Feb. 19, 2021 and entitled “ALWAYS-ON WAKE ON MULTI-DIMENSIONAL PATTERN DETECTION (WOMPD) FROM A SENSOR FUSION CIRCUITRY”, the entire disclosure of which is wholly incorporated by reference herein.

### STATEMENT RE: FEDERALLY SPONSORED RESEARCH/DEVELOPMENT

Not Applicable

### BACKGROUND

### 1. Technical Field

The present disclosure relates generally to human-computer interfaces, and specifically voice-activated human-computer interfaces in which a multi-dimensional pattern detection from different sensors is a basis for enabling system wakeup.

### 2. Related Art

Virtual assistant systems are incorporated into a wide variety of consumer electronics devices, including smartphones/tablets, personal computers, wearable devices, smart speaker devices such as Amazon Echo, Apple HomePod, and Google Home, as well as household appliances and motor vehicle entertainment systems. In general, virtual assistants enable natural language interaction with computing devices regardless of the input modality, though most conventional implementations incorporate voice recognition and enable hands-free interaction with the device. Examples of possible functions that may be invoked via a virtual assistant include playing music, activating lights or other electrical devices, answering basic factual questions, and ordering products from an e-commerce site. Even within individual mobile applications installed on smartphones/tablets, there may be dedicated virtual assistants specific to the application that assist the user with, for example, navigating bank, credit card, and other financial accounts.

For power conservation and privacy reasons, conventional virtual assistant systems do not constantly monitor and process all inputs to the underlying device to determine whether one of the functions of the virtual assistant has been invoked. Rather, the system may monitor one input or a sequence of inputs that match a targeted wake condition. In the case of a voice-activated system, the audio input as captured by the microphone may be monitored for utterances of a “wake word” such as “Hi AON,” “Hey Ski,” “Hey Google,” “Hey Alexa” and the like. In the case of a smart phone, other than voice activation, the motion applied to the device as captured by onboard accelerometers/gyroscopes may be monitored for a sequence of motion data corresponding to the user holding up the device. Visual data, such as that captured by an onboard camera, may be monitored for the face of the user, and upon a positive facial recognition, the device or virtual assistant may be awoken.

In this way, only a portion of the device that handles the wake-up detection need be powered on and activated, thereby conserving power that a fully activated device may otherwise consume. Subsequently issued commands may be interpreted and acted upon by a main process that is activated by the wake controller. This technique is deficient in several respects, in that there is insufficient data on the overall context of the activation to wake the system. For example, waking via a keyboard entry such as “HELP,” but without other information regarding the context of the user's need for assistance may not necessarily indicate that a safety issue is present. Additional context would be desirable to make accurate assessments prior to waking the device.

Accordingly, there is a need in the art for combining multiple input data points to fully activate a device that has been placed into a sleep mode. There is also a need in the art for such a feature to not consume more than a few hundred microwatts of power, particularly in modern battery-powered consumer electronics devices.

### BRIEF SUMMARY

The embodiments of the present disclosure contemplate a multi-dimensional wake-up based on a plurality of sensor pattern decisions. The system may remain in an idle state until a wake-up sensor fusion circuit detects a multiple input pattern that may be related to voice, human activity, sound-based events, sound-based contexts, images, and other sensor patterns.

One embodiment of the present disclosure may be a device wake-up system. It may include one or more sensors each receptive to an external input. The respective external inputs may be translatable to corresponding signals. The system may also include one or more feature extractors connected to a respective one of the one or more sensors. The feature extractors may be receptive to the signals outputted from the sensors, and the feature data may be associated with the signals being generated by the corresponding one of the one or more feature extractors. There may also be one or more inference circuits that are connected to a respective one of the one or more feature extractors. Inference decisions may be generated from patterns of the feature data generated by a corresponding one of the one or more feature extractors. The system may further include a decision combiner that is connected to each of the one or more inference circuits. A wake signal may be generated based upon an aggregate of the inference decisions provided by the one or more inference circuits.

Another embodiment of the present disclosure may be a method for waking a computing device. The method may include a step of receiving one or more external inputs on respective ones of sensors. The external inputs may be converted to corresponding signals by the sensors. There may also be a step of extracting feature data sets from each of the signals, along with a step of generating inference decisions for each of the extracted feature data sets based upon individual patterns thereof. The method may also include combining the generated inference decisions to generate a wake signal based upon an aggregate of the inference decisions of at least one of the extracted feature data sets. This method may also be performed with one or more programs of instructions executable by the computing device, with such programs being tangibly embodied in a non-transitory program storage medium.

The present disclosure will be best understood by reference to the following detailed description when read in conjunction with the accompanying drawings.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a block diagram of an exemplary primary data processing device that may be utilized in connection with various embodiments of the present disclosure;

FIG. 2 is a block diagram illustrating a general implementation of a wake on multi-dimensional pattern detection according to an embodiment of the present disclosure; and

FIG. 3 is a flow chart of a general process for wake on multi-dimensional pattern detection.

### DETAILED DESCRIPTION

The detailed description set forth below in connection with the appended drawings is intended as a description of the several presently contemplated embodiments of a wake on multi-dimensional pattern detection. This description is not intended to represent the only form in which the embodiments of the disclosed invention may be developed or utilized. The description sets forth the functions and features in connection with the illustrated embodiments. It is to be understood, however, that the same or equivalent functions may be accomplished by different embodiments that are also intended to be encompassed within the scope of the present disclosure. It is further understood that the use of relational terms such as first and second and the like are used solely to distinguish one from another entity without necessarily requiring or implying any actual such relationship or order between such entities.

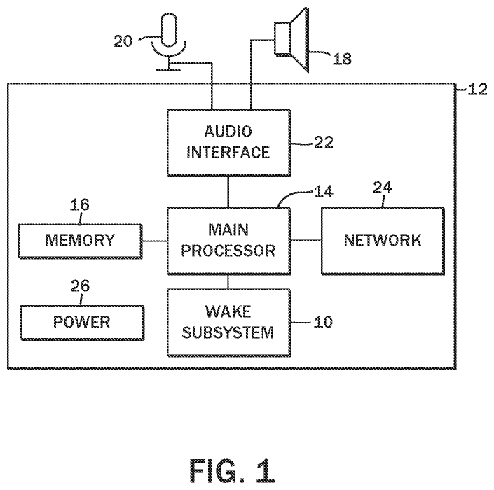

The present disclosure envisions multiple sensor fusion, and pattern detection based upon the data from such sensors, to evaluate entry of a wake state while consuming a minimal amount of power while in a sleep state. With reference to the block diagram of FIG. 1, a device wake-up subsystem 10 may be incorporated into a primary data processing device 12. By way of example only and not of limitation, the primary data processing device 12 may be a smart speaker incorporating a virtual assistant with which users may interact via voice commands. In this regard, the primary data processing device 12 includes a main processor 14 that executes pre-programmed software instructions that correspond to various functional features of the primary data processing device 12. These software instructions, as well as other data that may be referenced or otherwise utilized during the execution of such software instructions, may be stored in a memory 16. As referenced herein, the memory 16 is understood to encompass random access memory as well as more permanent forms of memory.

In view of the primary data processing device 12 being a smart speaker, it is understood to incorporate a loudspeaker 18 that outputs sound from corresponding electrical signals applied thereto. Similarly, the primary data processing device 12 may incorporate a microphone 20 for capturing sound waves and transducing the same to an electrical signal. Both the loudspeaker 18 and the microphone 20 may be connected to an audio interface 22, which is understood to include at least an analog-to-digital converter (ADC) and a digital-to-analog converter (DAC). It will be appreciated by those having ordinary skill in the art that the ADC is used to convert the electrical signal transduced from the input audio waves to discrete-time sampling values corresponding to instantaneous voltages of the electrical signal. This digital data stream may be processed by the main processor, or a dedicated digital audio processor. The DAC, on the other hand, converts the digital stream corresponding to the output audio to an analog electrical signal, which in turn is applied to the loudspeaker 18 to be transduced to sound waves. There may be additional amplifiers and other electrical circuits that within the audio interface 22, but for the sake of brevity, the details thereof are omitted.

The primary data processing device 12 may also include a network interface 24, which serves as a connection point to a data communications network. This data communications network may be a local area network, the Internet, or any other network that enables an communications link between the primary data processing device 12 and a remote node. In this regard, the network interface 24 is understood to encompass the physical, data link, and other network interconnect layers.

As the primary data processing device 12 is electronic, electrical power must be provided thereto in order to enable the entire range of its functionality. In this regard, the primary data processing device 12 includes a power module 26, which is understood to encompass the physical interfaces to line power, an onboard battery, charging circuits for the battery, AC/DC converters, regulator circuits, and the like. Those having ordinary skill in the art will recognize that implementations of the power module 26 may span a wide range of configurations, and the details thereof will be omitted for the sake of brevity.

Although certain specifics of the primary data processing device 12 have been described in the context of a smart speaker, the embodiments of the present disclosure contemplates the device wake-up subsystem 10 being utilized with other devices that are understood to be broadly encompassed within the scope of the primary data processing device 12. For instance, instead of the smart speaker, the primary data processing device 12 may be a smart television set, a smartphone, or any other suitable electronic device that may benefit from reduced power consumption while in a sleep state, but also being immediately available to being processing inputs upon being awoken in real time.

As will be described in further detail below, the device wake-up subsystem 10 may likewise be implemented as a set of executable software instructions that correspond to various functional elements thereof. These instructions that are specific to the device wake-up subsystem 10 may be executed by the main processor 14, or with a dedicated processor that is specific to the device wake-up subsystem 10. To the extent the device wake-up subsystem 10 is implemented as a separate hardware module, some of the aforementioned components that are a part of the primary data processing device 12 such as memory may be separately incorporated.

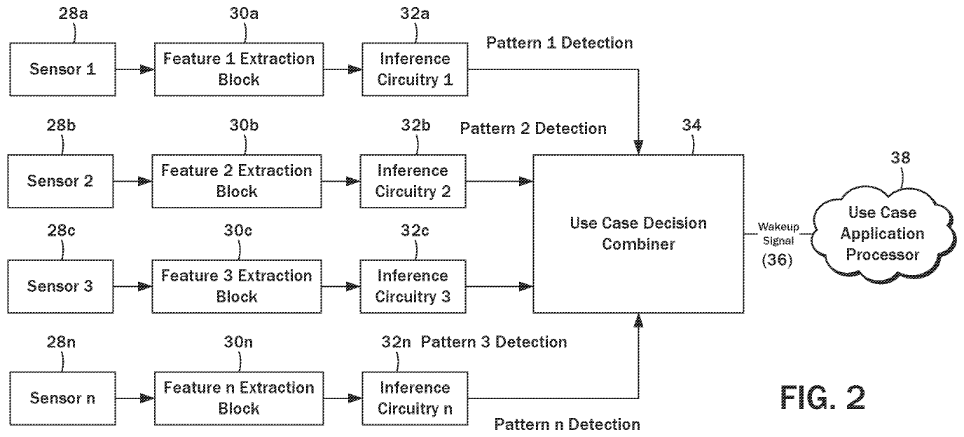

With reference to the block diagram of FIG. 2, the device wake-up subsystem 10 is understood to capture data from multiple sensors 28. In the illustrated example, there is a first sensor 28a, a second sensor 28b, and a third sensor 28c, as well as an additional indeterminate number of sensors 28n. As referenced herein, the sensor 28 is understood to be a device that captures some physical phenomenon and converts the same to an electrical signal that is further processed. For example, the sensor 28 may be a microphone/acoustic transducer that captures sound waves and converts the same to analog electrical signals, as discussed above. In another example, the sensor 28 may be an imaging sensor that captures incoming photons of light from the surrounding environment, and converts those photons to electrical signals that are arranged as an image of the environment. Furthermore, the sensor 28 may be motion sensor such as an accelerometer or a gyroscope that generates acceleration/motion/orientation data based upon physical forces applied to it. The sensors 28 as shown in the block diagram are understood to encompass all pertinent circuitry for conditioning and converting the environmental information into a data or streams of data upon which various processing operations may be applied. The embodiments of the present disclosure and not limited to any particular sensor or set of sensors, or any number of sensors.

The information captured by the plurality of sensors 28 may be used to determine whether the primary data processing device 12 is awoken. Each of the sensors 28 are connected to a corresponding feature extractor 30. In the example embodiment shown, there is a first feature extractor 30a connected to the output of the first sensor 28a, a second feature extractor 30b connected to the output of the second sensor 28b, a third feature extractor 30c connected to the output of the third sensor 28c, and an indeterminate feature extractor 30n connected to the output of the indeterminate sensor 28n.

The feature extractors 30 are understood to be specific to the sensors 28 to which they are connected. In one exemplary embodiment, the first sensor 28a may be the microphone for capturing audio. In this case, the feature extractor 30a may be a Mel-frequency cepstral coefficients (MFCCs) generator, Mel-Bands, per-channel energy normalized (PCEN) mel spectrograms or any suitable frequency domain representation. As will be appreciated by those having ordinary skill in the art, MFCCs are understood to be a representation of the power spectrum of a sound and may be derived using commonly known techniques. The derived coefficients are understood to correspond features of the captured audio. In another exemplary embodiment, the second sensor 28b may be a motion sensor such as an accelerometer or a gyroscope. In such case, the feature extractor 30b may be a simple router of time domain samples received from such accelerometer or gyroscope. Generally, the feature extractor 30 processes the incoming data from the sensors 28 to derive an initial understanding of the physical phenomena captured thereby. Accelerometers or gyroscopes are usually found in wearables to track human activity. Possible features that are extracted or collected from accelerometers or gyroscopes are the positional XYZ coordinates, velocity, inertia, different angles of rotations, etc.

The features derived by the individual feature extractors 30 are provided to inference circuitry 32, which are also specific to the sensors 28 and the feature extractors 30 to which they are connected. Thus, the first inference circuitry 32a is connected to the output of the first feature extractor 30a, the second inference circuitry 32b is connected to the output of the second feature extractor 30b, the third inference circuitry 32c is connected to the output of the third feature extractor 30c, and the indeterminate inference circuitry 32n is connected to the output of the indeterminate feature extractor 30d. In one embodiment, the inference circuitry 32 may be a multi-class classifiers neural network, or another type of machine learning system.

The inference circuitry 32, to the extent it is a multi-class classifiers neural network, may be implemented in accordance with a variety of known configurations. One is a deep learning convolutional neural network (CNN), while another is the recurrent neural network (RNNs) in the form of long short-term memory networks (LSTMs) or gated recurrent units (GRU) for example. Still another implementation is multilayer perceptrons (MLPs). Any combination of these types of NN architectures can be used to build the inference network. These neural networks may be implemented with custom circuitry hardware that reduces the power consumption to less than 100 microwatts.

Each of the outputs from the inference circuitry 32 are connected to a decision combiner 34, with the detections from each block, that is, the sensor 28, the feature extractor 30, and the inference circuitry 32, being processed to generate a final decision from the multi-dimensional system. If the decision combiner 34 determines that the primary data processing device 12 is to be awakened based upon the pattern of the inputs provided thereto from the blocks, the wake signal is generated to an application processor 36. The decision combiner 34 may be a simple logic circuit, or it may be a neural network combiner that may base the final wake decision on different weighted factors applied to the various inputs. For example, a first neural network detects wake word, command, context (Alexa, Ok google, Open door, hectic environment) based on voice/audio signals and a second neural network detects type of human activity based on data collected from sensors. Each of these networks provide specific metrics that could be combined to form a single metric for a final decision. The combination process can be in the form of a simple logic or more elaborate in the form of a third neural network. Sequential detection with priority, e.g.: microphone neural network detects via motor anomaly through acoustic analytics, then vibration sensor detects abnormal vibration movements, the decision maker mechanism will decide to notify user with siren or flashing lights.

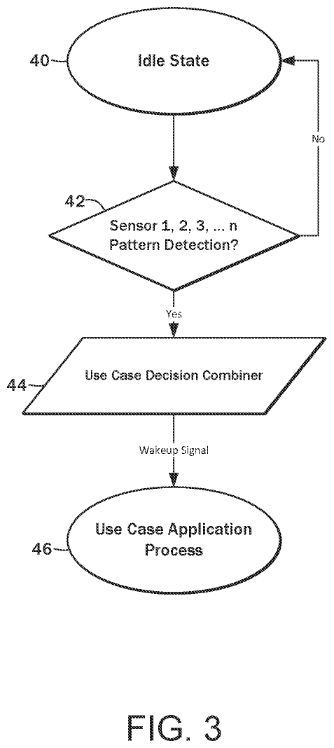

With reference to the flowchart of FIG. 3, based on the foregoing configuration of the device wake-up subsystem 10, one embodiment of a method for waking the primary data processing device 12 begins with an idle state 40. The data signal input to each sensor is sent to sensor specific feature extraction block, the sensor specific inference circuitry acts on the detected feature and resultant pattern generated. In a decision block 42, the data from each of the sensors 28 is evaluated, and if a matching pattern is detected, proceeds to a decision combining step 44. Otherwise, the idle state 40 is resumed. A wakeup signal 36 is generated and passed to the application process 38 in a step 46.

The device wake-up subsystem 10 and the process of waking the primary data processing device 12 has been described in general terms, though a variety of specific use cases are contemplated in accordance with the embodiments of the present disclosure. One possible use case is waking up a smart device (e.g., a smart speaker, smart display, etc.) with a combination of a wake word and an image of a human user. The first sensor 28a may thus be a microphone, and the second sensor 28b may be an imaging device. By requiring both a human image and the detection of an uttered wake word, false triggers may be avoided when a similar wake word is heard from another machine or device such as a television set or radio, rather than a real human user.

Another possible use case is awakening a smartphone or other like communication device with a keyword such as “HELP,” while simultaneously detecting other human sounds such as that associated with screaming or a panic state. In this case, the first sensor 28a and the second sensor 28 may be the microphone, with each separate audio input being fed to independent feature extractors 30a, 30b and corresponding inference circuitry 32a, 32b. However, it is also possible to route the audio data from a single microphone/first sensor 28a to multiple feature extractors 30 and inference circuitry 32.

As a variation of this use case, it may be possible to wake the smartphone with a voice keyword such as “help,” while concurrently detecting a fall as sensed by motion sensors. In addition to a microphone, the second sensor 28 may be a gyroscope or accelerometer.

Still another use case is an alarm system that awakens from a combination of a sound-based event and an image-based event. The sound-based event may be, for example, the sound of glass breaking, while the image-based event may be, for example, an outline of human with facial features concealed. In this case, the first sensor 28a may be a microphone, and the second sensor 28b may be an imaging device.

The foregoing use cases may be implemented with other battery-operated devices such as safety wearables (e.g., jewelry) to detect simultaneous panic speech and sound with unexpected body motions such as falling. Additionally, the device wake-up subsystem 10 may find application in security cameras that combine image and voice inputs. The device wake-up subsystem 10 may also be implemented in television remote controls, hearables, and so on. Other like applications/uses cases for the device wake-up subsystem 10 are deemed to be within the purview of those having ordinary skill in the art.

The neural networks utilized in the embodiments of the present disclosure such as the inference circuitry 32 and the decision combiner 34 may be trained in a variety of ways. Generally, a neural network is a classifier that makes decisions on a sample space of mutually exclusive classes. Training is a form of supervised learning that requires the trainer to provide labeled data such that the neural network can learn the characteristics of a particular class. Specifically, the neural network is provided with data, such as a picture of a dog, or an audio sample, and its corresponding label, such as an identification of the dog, or the content of the audio sample. The multi-dimensional pattern detection classifier training method may be modularized to be multiple individual trainings, or one full end-to-end training.

In embodiments where the training is modularized, the decision combiner 34 may be a logical processor that receives the classification outputs from each neural network, that is, the inference circuitry 32, feature extractor 30, and sensor 28, and makes wake-up decisions based on predetermined conditions. Each neural network may be appropriately labeled to expect all mutually exclusive inputs depending on its sensor. For example, the image sensor may be trained for a given adult, toddler, dog, etc. The sound sensor 28, e.g., the microphone, may be trained for the desired wake words, commands, or context inputs. The labels from each sensor may be provided separately as the neural network is specific to the data from the associated sensor 28.

In alternative embodiments where the training is end-to-end, the decision combiner 34 is also a neural network, thereby turning the otherwise modularized system into one full end-to-end training system. The trainer no longer trains each individual neural network with sensor detection outputs. Rather, the trainer will instead label the data from multiple sensors as wake-up decisions depending on the aligned temporal states. This implies that the data from each sensor aligns temporally before being labeled as “wakeup” “not wakeup” or other desired decision.

The particulars shown herein are by way of example and for purposes of illustrative discussion of the embodiments of a wake on multi-dimensional pattern detection, and are presented in the cause of providing what is believed to be the most useful and readily understood description of the principles and conceptual aspects. In this regard, no attempt is made to show details with more particularity than is necessary, the description taken with the drawings making apparent to those skilled in the art how the several forms of the present disclosure may be embodied in practice.

What is claimed is:

1. A device wake-up system comprising:
one or more sensors each receptive to an external input, the respective external inputs being translatable to corresponding signals;
one or more feature extractors connected to a respective one of the one or more sensors and receptive to the signals outputted therefrom, feature data associated with the signals being generated by the corresponding one of the one or more feature extractors;
one or more inference circuits connected to a respective one of the one or more feature extractors, inference decisions being generated from patterns of the feature data generated by a corresponding one of the one or more feature extractors; and
a decision combiner connected to each of the one or more inference circuits, a wake signal being generated based upon an aggregate of the inference decisions provided by the one or more inference circuits.

2. The system of claim 1, wherein the wake signal is output to an application processor.

3. The system of claim 1, wherein one of the one or more sensors is a microphone and the external input is an audio wave.

4. The system of claim 1, wherein one of the one or more sensors is an image sensor and the external input is light photons corresponding to an image.

5. The system of claim 1, whereon one of the or more sensors is a motion sensor, and the external input is physical motion applied thereto.

6. The system of claim 1, wherein the inference circuits are implemented as a multi-class classifier neural network.

7. The system of claim 6, wherein the multi-class classifier neural network is selected from a group consisting of: a convolutional neural network (CNN), a long short term memory network (LSTM), a recurrent neural network (RNN), and a multilayer perceptron (MLP).

8. The system of claim 6, wherein the inference circuits consume less than 100 microwatts of power while in operation.

9. The system of claim 1, wherein the decision combiner is implemented as a logic circuit accepting as input each of the inference decisions provided by the one or more inference circuits, and generates an output of the wake signal.

10. The system of claim 1, wherein the decision combiner is implemented as a neural network.

11. The system of claim 1, wherein the inference circuits are implemented with a machine learning system.

12. A method for waking a computing device, comprising:
receiving one or more external inputs on respective ones of sensors, the external inputs being converted to corresponding signals thereby;
extracting feature data sets from each of the signals;
generating inference decisions for each of the extracted feature data sets based upon individual patterns thereof; and
combining the generated inference decisions to generate a wake signal based upon an aggregate of the inference decisions of at least one of the extracted feature data sets.

13. The method of claim 12, wherein one of the external inputs is audio and the one of the sensors is a microphone.

14. The method of claim 12, wherein one of the external inputs is light photons corresponding to an image and the one of the sensors is an imaging sensor.

15. The method of claim 12, wherein one of the external inputs is physical motion applied to the computing device and the one of the sensors is a motion sensor.

16. The method of claim 12, wherein the inference decisions are made by individual inference circuits each implemented as a independent multi-class classifier neural network.

17. The method of claim 16, wherein the multi-class classifier neural network is selected from a group consisting of: a convolutional neural network (CNN), a long short term memory network (LSTM), a recurrent neural network (RNN), and a multilayer perceptron (MLP).

18. The method of claim 16, wherein the multi-class classifier neural networks are independently trained, with the combining step being performed by a logic circuit accepting as input each of the inference decisions as provided by the one or more inference circuits.

19. The method of claim 12, wherein the combining of the inference decisions is performed by another neural network, and inference decisions generated from the extracted feature data sets and the combining of the inference decisions is based upon an aggregate end-to-end training.

20. An article of manufacture comprising a non-transitory program storage medium readable by a computing device, the medium tangibly embodying one or more programs of instructions executable by the computing device to perform a method for waking the computing device, the method comprising the steps of:
receiving one or more external inputs on respective ones of sensors, the external inputs being converted to corresponding signals thereby;
extracting feature data sets from each of the signals;
generating inference decisions for each of the extracted feature data sets based upon individual patterns thereof; and
combining the generated inference decisions to generate a wake signal based upon an aggregate of the inference decisions of at least one of the extracted feature data sets.
